(19) United States
(12) Patent Application Publication
(10) Pub. No.: US 2010/0271305 A1
(43) Pub. Date: Oct. 28, 2010

(54) OPTICAL MOUSE DEVICE AND OPTICAL DETECTING MODULE THEREOF

(76) Inventors: Hsu-Chih CHEN, Chung Ho City (TW); Tzung-Lin Lee, Chung Ho City (TW)

Correspondence Address: Muncy, Geissler, Olds & Lowe, PLLC, 4000 Legato Road, Suite 310, FAIRFAX, VA, 22033, US

(21) Appl. No.: 12/512,712

(22) Filed: Jul. 30, 2009

(30) Foreign Application Priority Data
Apr. 27, 2009 (TW) 98113923

(51) Int. Cl. G06F 3/033

(52) U.S. Cl. 345/166

(57) ABSTRACT

A mouse pen has an aspheric lens and a sensor disposed in a housing with an opening, wherein the aspheric lens is interposed between the sensor and the opening. The aspheric lens is tilted. The tilting angle and the position of the aspheric lens define the best resolution point for the sensor, which is different from the focus of the aspheric lens.

### RELATED APPLICATIONS

This application claims priority to Taiwan Application Serial Number 98113923, filed Apr. 27, 2009, which is herein incorporated by reference.

### BACKGROUND

1. Field of Invention

The present invention relates to an optical mouse device. More particularly, the present invention relates to an optical and mechanical design for the optical mouse device.

2. Description of Related Art

A mouse and a keyboard are standard input devices for a computer. However, because the using methods of the mouse and the keyboard are much different from a pen in writing and drawing, it takes time for a novice to study how to control the mouse and the keyboard. To solve the foregoing problem, a pen-type input device operated similar to the pen is developed, for example a pen-type optical mouse device.

### SUMMARY

A pen-type optical mouse device is provided. The pen-type optical mouse device comprises a housing with an opening opposite a working surface, a first aspheric lens and a sensor disposed in the housing. When the housing is pushed to move against a working surface, the opening will reveal the working surface. A light beam reflected from the working surface through the opening is converged by the first aspheric lens and detected by the sensor.

The first aspheric lens is interposed between the opening and the sensor. The first aspheric lens is tilted such that the optical axis of the first aspheric lens may not pass through the sensor. A first included angle between the first optical axis and a line extended from the center of the first aspheric lens to the sensor is between 0 degree and 90 degrees. In an embodiment of this invention, the first included angle is between 0 degree and 10 degrees.

The position of the sensor and the position of the first aspheric lens define a best resolution point for the sensor. When an object is placed at the best resolution point, the sensor will capture a clear image of the object through the first aspheric lens. Since the optical axis of the first aspheric lens does not pass through the sensor, the position of the best resolution point is different from the focus of the first aspheric lens.

Between the first aspheric lens and the sensor, there is no optical element capable of changing the direction of the light beam like a mirror. Therefore, the light beam converged by the first aspheric lens is directly incident to the sensor.

The invention also provides an optical detecting module of an optical mouse device. The optical detecting module can be set in a housing with an opening. The optical detecting module comprises a sensor and an aspheric lens, wherein the aspheric lens is interposed between the sensor and the opening. Between the aspheric lens and the sensor, no optical element capable of changing the direction of the light beam is disposed.

The aspheric lens comprises a center, a focus, and an optical axis passing through the center and the focus. The aspheric lens is tilted to the sensor and the optical axis does not pass through the sensor. In particular, a first included angle between the optical axis and a line extended from the center of the aspheric lens to the sensor is between 0 degree and 10 degrees.

The position of the sensor and the position of the aspheric lens define a best resolution point for the sensor, which is different from the focus. A second included angle between the optical axis and a line extended from the center to the best resolution point is larger than 0 degree and smaller than the first included angle. Alternatively, the second included angle is between 0 degree and 6 degrees.

In the foregoing, the first aspheric lens is tilted to the sensor, which defines the best resolution point. Consequently, the depth of field can be extended to the range from the best resolution point to the focus. Additionally, the light emitting diode is tilted to ensure most of the light beam reflected from the working surface passing through the first aspheric lens and detected by the sensor.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a conventional optical mouse;

FIG. 2 is a perspective view of a light emitting diode;

FIG. 3 is a perspective view of a pen-type optical mouse device according to an embodiment of this invention;

FIG. 4 is a perspective view of the pen-type optical mouse device as illustrated in FIG. 3;

FIG. 5A is a perspective view of an integrator according to an embodiment of this invention;

FIG. 5B is a perspective view of an integrator according to another embodiment of this invention; and

FIG. 5C is a perspective view of an integrator according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

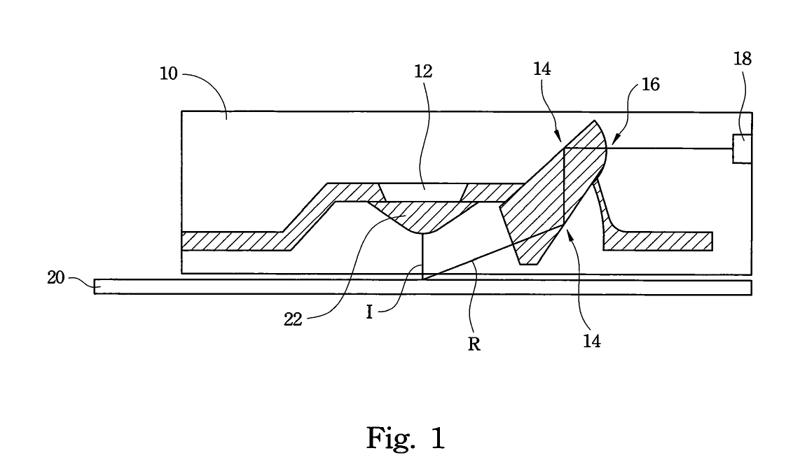

Please refer to FIG. 1, which is an optical and mechanical design for a normal optical mouse device 10. A luminance means 18 generates a light beam to pass through a spherical lens 16 and a reflective mirror 14 to incident on a working surface 20 like a desktop surface. The light beam reflected from the working surface 20 may pass through a lens 22 and be detected by a sensor 12. The depth of field of the lens 22 is limited due to the optical and mechanical design of the optical mouse device 10, for example the short focal distance of the lens 22, the distance between the lens 22 and the working surface 20, and the distance between the lens 22 and the sensor 12, etc. Consequently, the optical mouse device 10 has to be used on the working surface 20. If the optical mouse device 10 is lifted above the working surface 20, it may fail to detect the light beam reflected from the working surface 20.

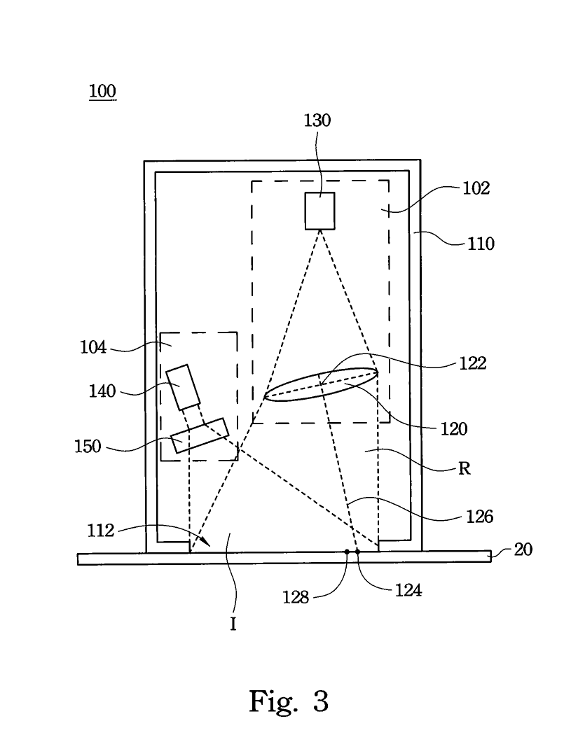

To solve to above problem, an embodiment of this invention provides a pen-type optical mouse device with different optical and mechanical designs. Please refer to FIG. 3, which is a perspective view of a pen-type optical mouse device 100 according to an embodiment of this invention. The pen-type optical mouse device 100 comprises a housing 110 with an opening 112. When the housing 110 is pushed to move against a working surface 20, the opening 112 reveals the working surface 20. The pen-type optical mouse device 100 comprises a luminance module 104 and an optical detecting module 102 disposed in the housing 110. The luminance module 104 provides uniform light beam passing through the opening incident on the working surface 20. The optical detecting module 102 receives the light beam reflected from the working surface 20 to capture the image of the working surface 20. The light beam incident on the working surface 20 is referred to as the incident light beam I hereinafter, and the light beam reflected from the working surface 20 through the opening 112 is referred to as the reflected light beam R hereinafter for convenience. Although the optical detecting module 102 described hereinafter is set in the pen-type optical mouse device 100 as an example, the optical detecting module 102 can be used in other optical device, such as an optical mouse device.

The optical detecting module 102 comprises a first aspheric lens 120 and a sensor 130, wherein both are disposed in the housing 110. The first aspheric lens 120 is interposed between the opening 112 and the sensor 130. The first aspheric lens 120 is operable for converging the reflected light beam R. The first aspheric lens 120 is a converging lens like a convex. In the embodiment of this invention, the first aspheric lens 120 is an aspheric bi-convex lens. The sensor 130 is operable for detecting the converted light beam.

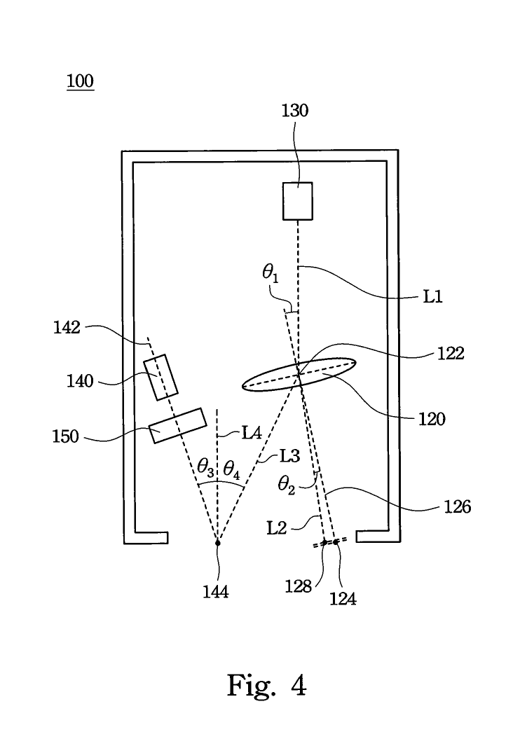

Please refer to FIG. 3 and FIG. 4. FIG. 4 is a perspective view of the pen-type optical mouse device 100 as illustrated in FIG. 3. The first aspheric lens 120 comprises a center 122, a focus 124, and a first optical axis 126. In an optical system, the optical axis is an imaginary line that defines the path along which light propagates through the system. For a lens, the optical axis passes through the center of the curvature of each surface of the lens, and coincides with the axis of rotational symmetry. In the embodiment of this invention, the first optical axis 126 passes through the center 122 and the focus 124 of the first aspheric lens 120.

The first aspheric lens 120 is tilted to the sensor 130 such that the first optical axis 126 doesn't pass through the sensor 130. Specifically, a linking line, referred to as a first line L1, extended from the center 122 of the first aspheric lens 120 to the sensor 130 is not parallel to the first optical axis 126. A first included angle θ1 between the first optical axis 126 and the first line L1 is between 0 degree and 90 degrees. In an embodiment of this invention, the first included angle θ1 is between 0 degree and 10 degrees. In an example, the first included angle θ1 is about 8.13 degrees.

In the embodiment of this invention, the first aspheric lens 120 and the sensor 130 are set to let the first line L1 be substantially perpendicular to the working surface 20.

The position of the sensor 130 and the position of the first aspheric lens 120 define a best resolution point 128 for the sensor 130. It is understandable that the distance between the first aspheric lens 120 and the sensor 130, and the angle from the first optical axis 126 to the sensor 126, which is the first included angle θ1, will affect the resolution of images captured by the sensor through the first aspheric lens 120. In the embodiment of this invention, the best resolution point 128 for the sensor 130 through the first aspheric lens 120 is a point where the sensor 130 will capture images with good resolution. When an object is placed at the best resolution point 128, the sensor 130 will capture a clear image of the object through the first aspheric lens 120.

Since the first optical axis 126 does not pass through the sensor 130, the position of the best resolution point 128 is different from the focus 124 of the first aspheric lens 120. The position difference of the best resolution point 128 and the focus 124 may be an angular shift, a radial shift, or combinations thereof.

In the embodiment of this invention, the best resolution point 128 is angularly shifted from the focus 124. A linking line, referred to as a second line L2, extended from the center 122 of the first aspheric lens 120 to best resolution point 128 is not parallel to the first optical axis 126. A second included angle θ2 between the first optical axis 126 and the second line L2 is between 0 degree and 90 degrees, which means the first optical axis 126 does not pass through the best resolution point 128. Furthermore, the second included angle θ2 is larger than 0 degree and smaller than the first included angle θ1. Alternatively, the second included angle θ2 is between 0 degree and 6 degrees. In an example, the first included angle θ1 is about 8.13 degrees and the second included angle θ2 is about 5.71 degrees.

To allow the sensor 130 to capture clear images of the working surface 20 outside the housing 110, the sensor 130 and the first aspheric lens 120 are disposed to let the best resolution point 128 be located in the opening 112. Therefore, when the pen-type optical mouse device 100 is pushed against the working surface 20, the working surface 20 is located at the best resolution point 128.

In the embodiment of this invention, the sensor 130 and the first aspheric lens 120 can further be set to let the best resolution point 128 and the focus 124 be located at different parts in the opening 112.

In the embodiment of this invention, a distance between the best resolution point 128 and the center 122 of the first aspheric lens 120 is shorter than a focal distance of the first aspheric lens 120. The focal distance of the first aspheric lens 120 is defined as a distance between the focus 124 and the center 122 of the first aspheric lens 120.

For the sensor 130, when the object is placed in a range from the best resolution point 128 to the focus 124, the sensor 130 will capture the image of the object with good resolution. Therefore, the depth of field of the optical detecting module 102 is extended to comprise the range near the focus 124, the range from the best resolution point 128 to the focus 124, and the range near the best resolution point 128.

It is noteworthy that there is no optical element capable of changing the direction of the light beam disposed between the first aspheric lens 120 and the sensor 130. Specifically, the optical element capable of changing the direction of the light beam is a mirror, a semi-transparent mirror, combinations thereof, or etc. Therefore, the light beam converged by the first aspheric lens 120 is directly incident to the sensor 130 without changing its direction.

The luminance module 104 of the pen-type optical mouse device 100 comprises a light emitting diode 140 for emitting the incident light beam 1. The light emitting diode 140 is disposed in the housing 110 and is tilted relative to the first aspheric lens 120. Specifically, the light emitting diode 140 is tilted to let most of the reflected light beam R pass through the first aspheric lens 120 such that the strength of the light beam detected by the sensor will be improved.

In the embodiment of this invention, the light emitting diode 140 and the first aspheric lens 120 are disposed symmetrically. In particular, the light emitting diode 140 comprises a second optical axis 142 extended passing through the center thereof, wherein the second optical axis 142 is substantially parallel to the light beam emitted by the light emitting diode 140. The second optical axis 142 and the opening 112 are intersected at a point 144 to form an included angle, which is equal to an included angle between the opening 112 and a linking line, referred to as a line L3, between the point 144 and the center 122.

Specifically, an imaginary line L4 parallel to the first line L1 is illustrated in FIG. 4. The second optical axis 142 and the imaginary line L4 are intersected to form a third included angle θ3. The line L3 and the imaginary line L4 are intersected to form a fourth included angle θ4 equal to the third included angle θ3. The third included angle θ3 is between 0 degree and 40 degrees. In an example, the third included angle θ3 is about 30.3 degrees.

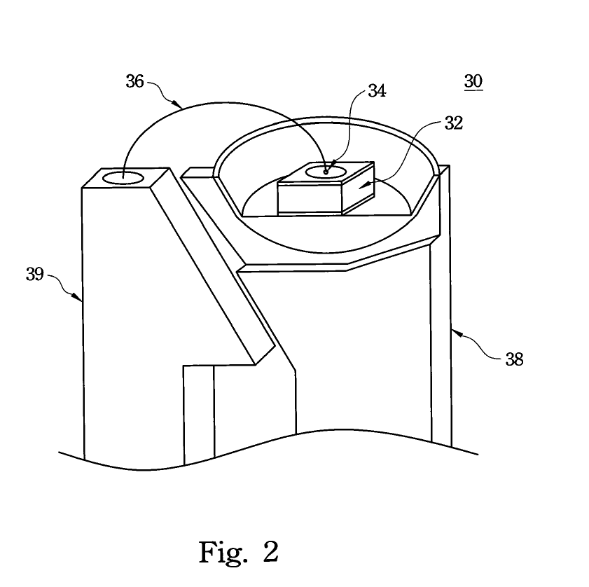

Please refer to FIG. 2, which is a perspective view of a typical light emitting diode 30. The typical light emitting diode 30 has a chip 32 electrically connected to the cathode lead 38. The chip 32 has a pad 34 disposed on the top thereof. The chip 32 electrically connects to the anode lead 39 through the pad 34 and a wire 36. The pad 34 is opaque and blocks light emitted from the chip 32. Therefore, when the typical light emitting diode 30 and the working surface are close enough, the shadow of the pad 34, which is called as the blind spot, can be seen, which will make the light not uniform and decrease the strength of the light.

To eliminate the blind spot, the luminance module 104 of the embodiment of this invention further comprises an integrator 150 operable to uniform the light beam emitted from the light emitting diode 140 in an embodiment of this invention. The integrator 150 is interposed between the light emitting diode 140 and the opening 112 in the housing 110. In particular, the integrator 150 is set on a path of the incident light beam 1.

Optical systems capable of uniform light are various, for example a diffuser, a lens array and etc. In the embodiment of this invention, the integrator 150 is operable to let the incident light beam I out of focus. Examples are described as follows.

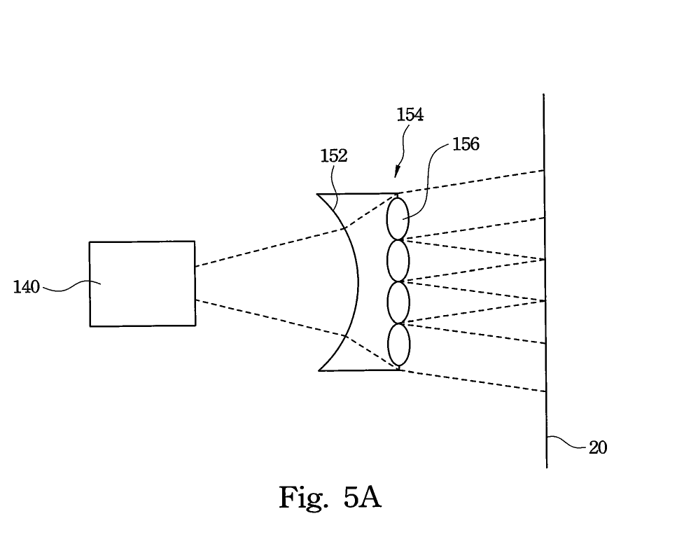

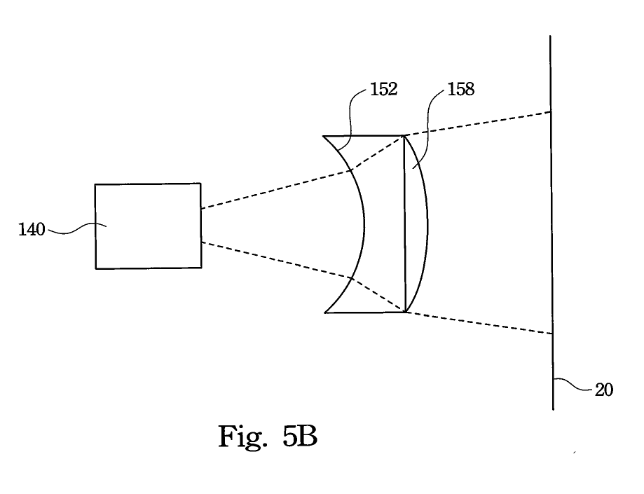

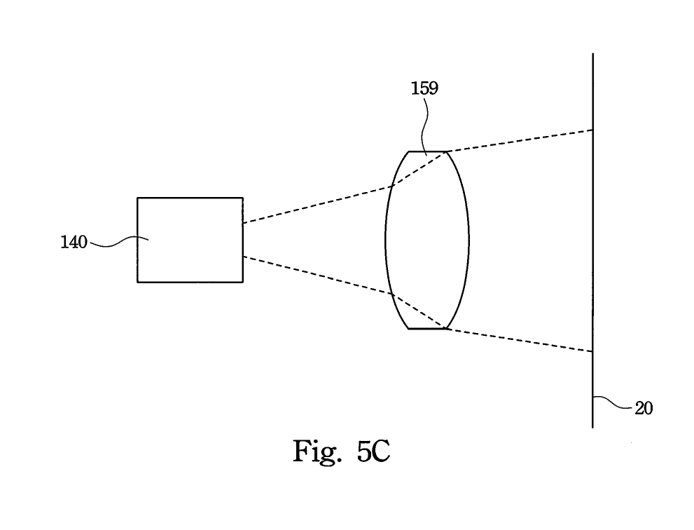

Refer to FIG. 3 and FIG. 5A at the same time. FIG. 5A is a perspective view of an integrator 150 according to an embodiment of this invention. The integrator 150 comprises a second aspheric lens 152 and a lens array structure 154. The second aspheric lens 152 is set in front of the light emitting diode 140 for diverging the light beam emitted from the light emitting diode 140. The second aspheric lens 152 can be a convex or a concave. In the embodiment of this invention, the second aspheric lens 152 is an aspheric concave lens.

The lens array structure 154 is interposed between the second aspheric lens 152 and the opening 112. The lens array structure 154 comprises convex lenses 156. The light beam diverged by the second aspheric lens 152 is incident on the convex lenses 156 uniformly. Each convex lens 156 then converges part of the diverged light beam incident thereon. The converged light beams are overlapped to form uniform light on the working surface 20 as illustrated in FIG. 5A. Therefore, the incident light beam I becomes uniform and the blind spot can be eliminated.

In the embodiment of this invention, the focal distance of each convex lens 156 is longer than a distance between the convex lens 156 and the opening 112. In other words, the light beam incident on the working surface 20 is out of focus.

The convex lenses 156 on the lens array structure 154 can be identical or different. In the embodiment of this invention, the focal distance of each convex lens 156 is the same as one another. Alternatively, the focal distance of each convex lens 156 can be different from one another.

Refer to FIG. 3 and FIG. 5B at the same time. FIG. 5B is a perspective view of an integrator 150 according to another embodiment of this invention. The integrator 150 comprises the second aspheric lens 152 and a third aspheric lens 156, wherein the third aspheric lens 158 is interposed between the second aspheric lens 152 and the opening 112.

The second aspheric lens 152 is operable for diverging the light beam emitted from the light emitting diode 140. As the above, the second aspheric lens 152 can be a convex or a concave. In the embodiment of this invention, the second aspheric lens 152 is an aspheric concave lens.

The third aspheric lens 158 is operable for converging the diverged light beam from the second aspheric lens 152. The third aspheric lens 158 is a converging lens like a convex. In the embodiment of this invention, the third aspheric lens 158 is an aspheric convex lens. A focal distance of the third aspheric lens 158 is longer than a distance between the third aspheric lens 158 and the opening 112, and therefore, the light beam incident on the working surface 20 through the third aspheric lens 158 is out of focus.

Refer to FIG. 3 and FIG. 5C at the same time. FIG. 5C is a perspective view of an integrator 150 according to another embodiment of this invention. The integrator 150 comprises an aspheric bi-convex lens 159, which has two opposite aspheric convex surfaces. A focal distance of the aspheric bi-convex lens 159 is longer than a distance between the aspheric bi-convex lens 159 and the opening 112, and therefore, the light beam incident on the working surface 20 through the aspheric bi-convex lens 159 is out of focus. In the foregoing, because the light beam incident on the working surface 20 is out of focus, the blind spot can't image on the working surface 20.

In the foregoing, the pen-type optical mouse device 100 and the optical detecting module 102 thereof have the first aspheric lens 120 tilted to the sensor 130 to define the best resolution point 128 different from the focus 124. Consequently, the depth of field can be extended to comprise the range from the best resolution point 128 to the focus 124.

The pen-type optical mouse device 100 and the luminance module 104 thereof have the light emitting diode 140 tilted to the first aspheric lens 120 to ensure most of the light beam reflected from the working surface 20 passes through the first aspheric lens 120 and is detected by the sensor 130. The integrator 150 can uniform the light beam by allowing the light beam to be out of focus.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A pen-type optical mouse device, comprising:
a housing comprising an opening opposite a working surface;
a first aspheric lens disposed in the housing for converging at least a light beam reflected from the working surface through the opening; and
a sensor disposed in the housing for detecting the converted light beam, wherein the first aspheric lens is interposed between the opening and the sensor, a first included angle between an optical axis of the first aspheric lens and a first line extended from a center of the first aspheric lens to the sensor is between 0 degree and 90 degrees, a best resolution point for the sensor defined by the position of the sensor and the position of the first aspheric lens is different from a focus of the first aspheric lens, and there is no optical element for changing the direction of the light beam disposed between the first aspheric lens and the sensor.

2. The pen-type optical mouse device of claim 1, wherein a second included angle between the optical axis of the first aspheric lens and a second line extended from the center of the first aspheric lens to the best resolution point is larger than 0 degree and smaller than the first included angle.

3. The pen-type optical mouse device of claim 1, wherein a second included angle between the optical axis of the first aspheric lens and a second line extended from the center of the first aspheric lens to the best resolution point is between 0 degree and 6 degrees.

4. The pen-type optical mouse device of claim 1, wherein the first included angle is between 0 degree and 10 degrees.

5. The pen-type optical mouse device of claim 1, wherein the best resolution point is located in the opening.

6. The pen-type optical mouse device of claim 1, wherein the best resolution point and the focus of the first aspheric lens are located at different parts in the opening.

7. The pen-type optical mouse device of claim 1, wherein a distance between the best resolution point and the center of the first aspheric lens is shorter than a focal distance of the first aspheric lens.

8. The pen-type optical mouse device of claim 1, further comprising:
a light emitting diode disposed in the housing for emitting the light beam incident on the working surface, wherein the light emitting diode is tilted to let the light beam reflected from the working surface pass through the first aspheric lens.

9. The pen-type optical mouse device of claim 8, wherein a third included angle between an optical axis of the light emitting diode and the first line extended from the center of the first aspheric lens to the sensor is between 0 degree and 40 degrees.

10. The pen-type optical mouse device of claim 8, further comprising:
an integrator interposed between the light emitting diode and the opening on a path of the light beam in the housing for uniforming the light beam.

11. The pen-type optical mouse device of claim 10, wherein the integrator comprises:
a second aspheric lens for diverging the light beam emitted from the light emitting diode; and
a lens array structure interposed between the second aspheric lens and the opening, the lens array structure comprising a plurality of convex lenses, wherein each convex lens is operable for converging a part of the diverged light beam from the second aspheric lens.

12. The pen-type optical mouse device of claim 11, wherein a focal distance of each convex lens is longer than a distance between the convex lens and the opening.

13. The pen-type optical mouse device of claim 11, wherein focal distances of the convex lenses are the same.

14. The pen-type optical mouse device of claim 10, wherein the integrator comprises:
a second aspheric lens for diverging the light beam emitted from the light emitting diode; and
a third aspheric lens interposed between the second aspheric lens and the opening for converging the diverged light beam from the second aspheric lens, wherein a focal distance of the third aspheric lens is longer than a distance between the third aspheric lens and the opening.

15. The pen-type optical mouse device of claim 10, wherein the integrator comprises:
an aspheric bi-convex lens, wherein a focal distance of the aspheric bi-convex lens is longer than a distance between the aspheric bi-convex lens and the opening.

16. An optical detecting module of an optical mouse device comprising:
a sensor disposed in a housing with an opening; and
an aspheric lens interposed between the sensor and the opening in the housing, wherein a first included angle between the optical axis of the aspheric lens and a first line extended from a center of the aspheric lens to the sensor is between 0 degree and 10 degrees, a best resolution point for the sensor defined by the position of the sensor and the position of the aspheric lens is different from a focus of the aspheric lens, a second included angle between the optical axis of the aspheric lens and a second line extended from the center of the aspheric lens to the best resolution point is larger than 0 degree and smaller than the first included angle, and there is no optical element for changing the direction of the light beam being disposed between the aspheric lens and the sensor.

17. The optical detecting module of the optical mouse device of claim 16, wherein the second included angle is between 0 degree and 6 degrees.

18. The optical detecting module of the optical mouse device of claim 16, wherein the best resolution point is located in the opening.

19. The optical detecting module of the optical mouse device of claim 16, wherein a distance between the best resolution point and the center is shorter than a focal distance of the aspheric lens.
